(19) United States
(12) Patent Application Publication
(10) Pub. No.: US 2015/0023704 A1
(43) Pub. Date: Jan. 22, 2015

(54) IMAGE FIXING APPARATUS

(71) Applicant: CANON KABUSHIKI KAISHA, Tokyo (JP)

(72) Inventors: Toru Imaizumi, Kawasaki-shi (JP); Takashi Narahara, Mishima-shi (JP); Atsutoshi Ando, Yokohama-shi (JP); Yasuhito Minamishima, Odawara-shi (JP); Masafumi Maeda, Yokohama-shi (JP); Tomoya Tateishi, Kamakura-shi (JP)

(21) Appl. No.: 14/336,270

(22) Filed: Jul. 21, 2014

(30) Foreign Application Priority Data
Jul. 22, 2013 (JP) 2013-151617
Jun. 23, 2014 (JP) 2014-128147

(51) Int. Cl. G03G 15/20

(52) U.S. Cl. CPC G03G 15/2053
USPC 399/329

(57) ABSTRACT

A fixing device for fixing a toner image formed on a sheet includes a cylindrical film; a heater having a first surface contacting an inner surface of the film; an opposed member forming a press-contact portion with the film therebetween; a supporting member for supporting a second surface of the heater opposite the first surface; and a heat conduction member contacting the second surface, wherein in a generatrix direction of the film, an end portion of a contact region between the heat conduction member and the second surface is at or inside an end portion of the press-contact portion. In a region from an end portion of the contact region to an outside of an end portion of the press-contact portion with respect to the direction, the supporting member includes a first region not contacting the second surface and a second region contacting the second surface outside the first region.

### FIELD OF THE INVENTION AND RELATED ART

The present invention relates to an image fixing apparatus (image heating apparatus) which is desirable as a fixing device to be mounted in an image forming apparatuses such as an electrophotographic copying machine, an electrophotographic laser beam printer, etc.

There are various fixing apparatuses (devices) which are mountable in an electrophotographic copying machine, an electrophotographic copying machine, and the like. One of them has been known as a fixing device of the heating film type. A fixing device of the heating film type has a heater, a film, a pressure roller, etc. The heater has a ceramic substrate, and a heat generating resistor placed on the substrate. The film is cylindrical and rotates in contact with the heater. The pressure roller forms a nip by sandwiching the film between itself and the heater. In operation, a sheet of recording medium, on which an unfixed toner image is present, is conveyed through the nip while being heated. Thus, the toner image on the sheet of recording medium is thermally fixed to the sheet.

One of the merits which a fixing device of the heating film type has is that it is relatively short in the length of time it takes for its temperature to rise to a level at which fixation is possible, after power begins to be supplied to its heater. Thus, a printer which employs a fixing device of the heating film is relatively short in the length of time (FPOT: First Print Out Time) it takes for the printer to output the first image after the inputting of a print start command. Another merit which a fixing device of this type has is that it is small in the amount of electrical power it consumes while it is kept on standby for a print start command.

By the way, it has been known that as a substantial number of small prints are continuously outputted by a printer having a fixing device of the heating film type, with the same chronological intervals as that for large prints, the out-of-sheet-path portion of the heater, that is, the portion of the heater, which is outside the sheet path, excessively increases in temperature. As the out-of-sheet-path portion of the heater excessively increases in temperature (out-of-sheet-path temperature increase), the components, such as the pressure roller, of the fixing device sometimes are thermally damaged. Thus, it is desired that a printer which employs a fixing device of the heating film type is structured so that when it is used for continuously outputting a substantial number of small prints, it is widened in print interval, compared to when it is used for continuously outputting a substantial number of large prints, in order to prevent the out-of-sheet-path portion of the heater from excessively increasing in temperature.

However, widening print interval reduces an image forming apparatus in output, that is, print count per unit length of time. Thus, it is desired to make the output (print count per unit length of time) of a printer having a fixing device of the heating film type when a substantial number of small prints are continuously outputted, the same as that when a substantial number of large prints are continuously outputted.

Referring to FIG. 11, Japanese Laid-open Patent Application H11-84919 discloses a heating apparatus (device) having a metallic plate 14a between its heater 12 and thermally insulative supporting member 11. With the placement of the metallic plate 14a, which is a thermally conductive member, between thermally insulative member 11 and heater 12, it is possible to prevent the problem that the heater becomes nonuniform in temperature. In other words, it is possible to reduce the difference in temperature between the portion of the heater, which is outside the recording medium path (out-of-sheet-path portion), and the portion of the heater, which is within the recording medium path (sheet-path portion), which occurs as the “out-of-sheet-path temperature increase” occurs. However, if the metallic plate 14a is long enough to extend from one end of the heater to the other as shown in FIG. 11, the end portions of the sheet-path portion of the heater, in terms of the direction parallel to the generatrix of the film, are reduced in temperature, and therefore, the portions of the film, which correspond to the end portions of the sheet-path portion of the heater, are reduced in temperature, which possibly will cause an image forming apparatus output images which are unsatisfactory in fixation.

Japanese Laid-open Patent Application H11-84919 proposes also a fixing device which is provided with multiple metallic plates 14a. In the case of this fixing device, the metallic plates 14a are fitted in the recesses of the thermally insulative member 11.

### SUMMARY OF THE INVENTION

According to an aspect of the present invention, there is provided a fixing device for fixing a toner image formed on a recording material, on a recording material, said fixing device comprising a cylindrical film; a heater having a first surface contacting an inner surface of said film; an opposed member cooperating with said heater to form a press-contact portion with said film interposed therebetween; a supporting member for supporting a second surface of said heater opposite the first surface; and a heat conduction member contacting said second surface, wherein with respect to a generatrix direction of said film, an end portion of a contact region between said heat conduction member and said second surface is at or inside an end portion of said press-contact portion, and wherein in a region from an end portion of the contact region to an outside of an end portion of said press-contact portion with respect to the generatrix direction, said supporting member includes a first region not contacting said second surface and a second region contacting said second surface outside said first region.

Further features of the present invention will become apparent from the following description of exemplary embodiments (with reference to the attached drawings).

### BRIEF DESCRIPTION OF THE DRAWINGS

FIG. 1 is a sectional view of the fixing device in the first embodiment of the present invention, at a vertical plane which is perpendicular to the lengthwise direction of the fixing device and coincides in position to the center of the fixing device in terms of the lengthwise direction of the fixing device.

FIG. 2 is a front view of the fixing device (minus its center portion in terms of its lengthwise direction) in the first embodiment.

FIG. 3 is a plan view of the heater of the fixing device in the first embodiment, as seen from the side of its surface on which the heating film slides.

FIG. 4 is a drawing for showing the positional relationship among the supporting member, thermally conductive member, thermistor, and temperature fuses of the fixing device in the first embodiment.

FIG. 5(a) is a sectional view of the fixing device in the first embodiment, at a plane indicated by a pair of arrow marks I in FIG. 1; FIG. 5(b) is a plan view of the supporting member as seen from the side of its surface to which the thermally conductive member is attached; and FIG. 5 (c) is a drawing for describing the positional relationship among the supporting member, thermally conductive member, heater, film, and pressure roller of the fixing device, in the adjacencies of one of the lengthwise end of the pressure roller.

FIG. 6(a) is a drawing for describing the direction in which heat conducts through the heater and thermally conductive member; and FIG. 6(b) is a drawing for describing the direction in which heat conducts through the heater and thermally conductive member, in the adjacencies of one of their lengthwise ends.

FIG. 7(a) is a drawing for describing the power supply connector; and FIG. 7(b) is a drawing for describing the clip.

FIG. 8(a) is a drawing for describing the state of contact between the heater and thermally conductive member of the fixing device in the first embodiment, in the adjacencies of one of the lengthwise ends of the thermally conductive member; and FIG. 8(b) is a drawing for describing the state of contact between the heater and thermally conductive member of a comparative fixing device, in the adjacencies of one of the lengthwise ends of the thermally conductive member.

FIG. 9 is a drawing which shows the structure of the heater, supporting member, thermally conductive member, and pressure roller of the fixing device in the third embodiment of the present invention, in the adjacencies of one of the lengthwise end portions of the fixing device.

FIG. 10 is a drawing illustrating the characteristic features of the fixing device in the second embodiment of the present invention.

FIG. 11 is a drawing illustrating the structure of the heater and thermally conductive member of a fixing device in accordance with the prior art.

FIG. 12(a) is a drawing illustrating the structure of the pressure stay, supporting member, thermally conductive member, heater, and flange, of the fixing device in the first embodiment, as seen from the direction parallel to the recording medium conveyance direction; and FIG. 12(b) is a sectional view of the combination of the pressure stay, supporting member, thermally conductive member, and heater, of the fixing device in the first embodiment, at a plane which is perpendicular to the lengthwise direction of the fixing device and corresponds in position to the center of the fixing device in terms of the lengthwise direction of the fixing device.

FIG. 13 is a schematic sectional view of one of the modified versions of the fixing device in the first embodiment.

### DESCRIPTION OF THE PREFERRED EMBODIMENTS

Hereinafter, the present invention is described in detail with reference to appended drawings. The preferable embodiments of the present invention, which will be described hereafter, are some of the most preferable of the embodiments of the present invention. However, they are not intended to limit the present invention in scope. That is, the present invention is also applicable, within the gist of the present invention, to various known image heating apparatuses (devices) which are different in structure from those in the following embodiments.

### Embodiment 1

In this embodiment, an image heating apparatus in accordance with the present invention is described as a fixing apparatus (fixing device) of the heating film type, which is mountable in an image forming apparatus such as a printer, a copying machine, and the like, which is based on electrophotographic recording technologies.

### (1) Structure of Fixing Device 30

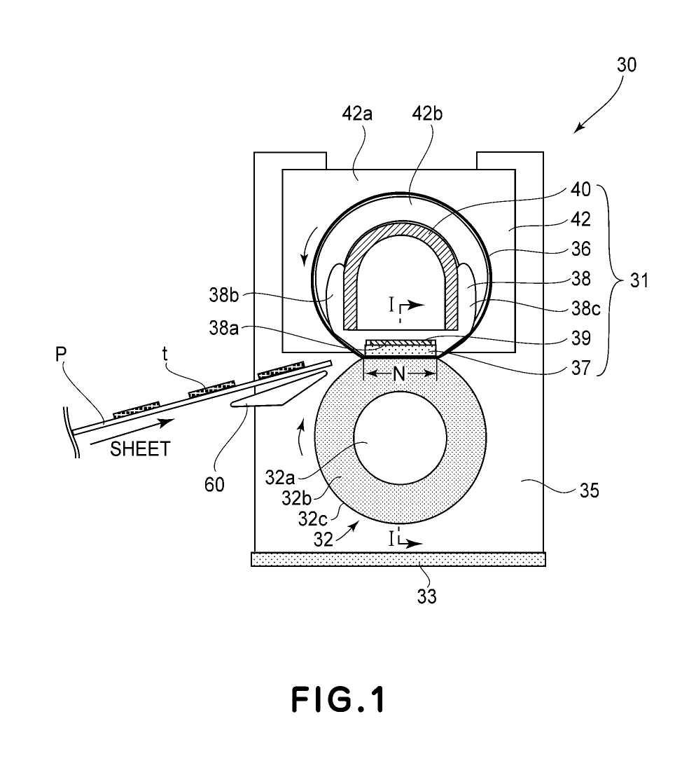

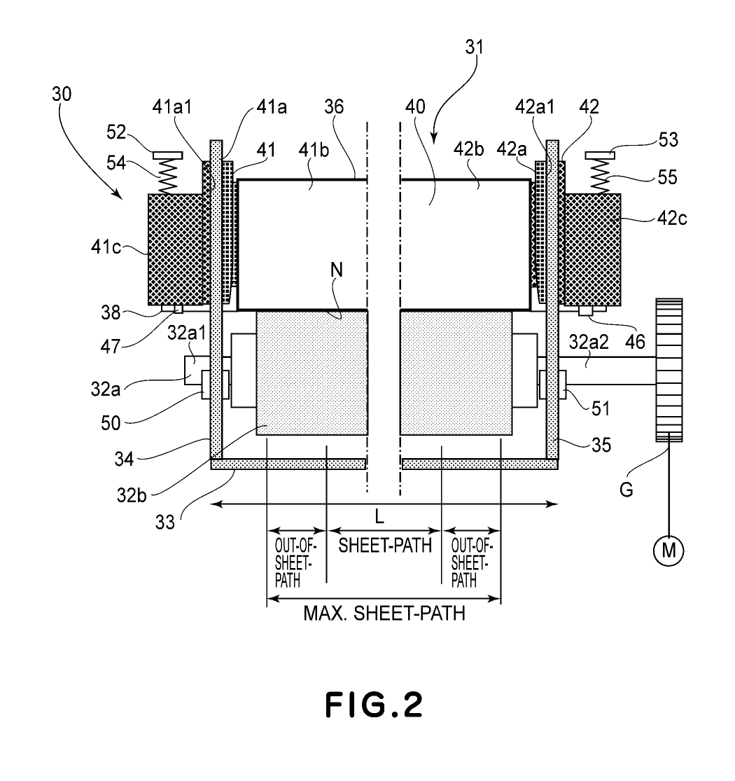

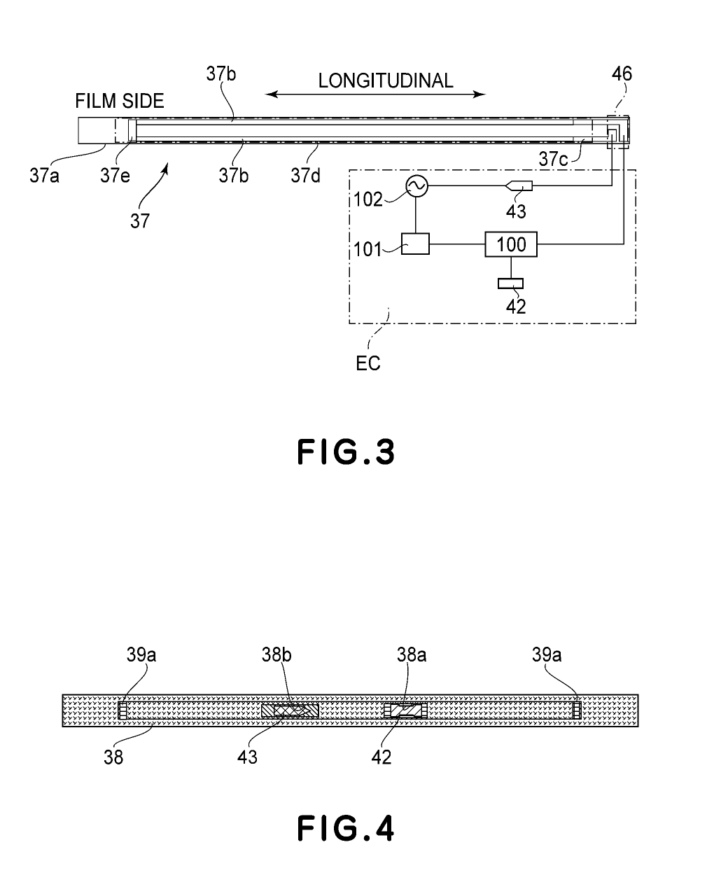

FIG. 1 is a sectional view of the fixing device 30 in this embodiment, at a plane which is perpendicular to the lengthwise direction of the fixing device 30 and corresponds in position to the center of the fixing device 30 in terms of the lengthwise direction of the fixing device 30. FIG. 2 is a front view of the fixing device 30 (minus its center portion in terms of its lengthwise direction) of the fixing device in this embodiment. In FIG. 2, for the sake of descriptive discretion, the film 36 is drawn as if it is transparent, and the components which are within the hollow of the film 36 and are contoured with solid lines, along with the lateral plates 34 and 35 of the frame 33. FIG. 3 is a front view of the heater 37 as seen from its side on which the film slides. FIG. 4 is a drawing which shows the positional relationship among the supporting member 38, thermally conductive member 39, thermistor 42, and temperature fuse 43.

Fixing device 30 has a film unit 31, and a pressure roller 32 as a pressure applying member. The film unit 31 has: a cylindrical film 36 as a cylindrical rotational member; the heater 37, as a heating member, which is in the form of a piece of plate; and a supporting member 38 which supports the heater 37. Further, the film unit 31 has: a thermally conductive member 39 which is between the heater 37 and supporting member 38; a pressure stay 40 as a reinforcing member for reinforcing the supporting member 38; and a pair of flanges 41 and 42, as regulating members, which regulate the film 36 in terms of the movement in the lengthwise direction of the fixing device 30.

The pressure roller 32, film 36, heater 37, supporting member 38, thermally conductive member 39, and pressure stay 40 are disposed so that their lengthwise direction becomes perpendicular to the recording medium conveyance direction. The film 36 is disposed in parallel to the pressure stay 32. The heater 37, supporting member 38, thermally conductive member 39, pressure stay 40 are disposed within the hollow of the film 36. The flanges 41 and 42 are disposed at the lateral edges of film 36, one for one.

The shape of the supporting member 38 is such that its cross-section at a plane parallel to the direction (which hereafter may be referred to as widthwise direction) parallel to the recording medium conveyance direction is roughly semicircular (FIG. 1). It is rigid, heat resistant, and thermally insulative. The material for the supporting member 38 is a liquid polymer resin. The pressure roller 32 side of the supporting member 38 is provided with a groove 38a, which extends in the lengthwise direction of the supporting member 38. It is in this groove 38a that the thermally conductive member 39 and heater 37 are fitted, being thereby supported by the supporting member 38. Further, the opposite surface of the supporting member 38 from the pressure roller 32 is provided with a pair of guiding portions 38b and 38c, which are roughly arc-shaped and are on the upstream and downstream sides, respectively, in terms of the recording medium conveyance direction. It is by these guiding portions 38b and 38c that the film 36 is properly held while the film 36 is rotated.

The pressure stay (reinforcing member) 40 is used for increasing the film unit 31 in rigidity (resistance to bending). It is formed by bending a long piece of stainless steel, which is 1.6 mm in thickness, in such a manner that its cross section at a plane parallel to the widthwise direction of the fixing device 30 becomes shaped like a letter U. The pressure stay 40 is disposed between the guiding portions 38b and 38c of the supporting member 38.

Referring to FIG. 3, the heater 37 has a substrate 37a, the lengthwise direction of which is parallel to the generatrix of the film 36. The “direction of the generatrix of the film 36” means the direction indicated by an arrow mark L in FIG. 2. It is the same as the above-described lengthwise direction of the fixing device 30. The material for the substrate 37a is a ceramic such as alumina, aluminum nitrate, etc. The heater 37 has also a pair of long and narrow heat generating members 37b, which are on the surface (which hereafter may be referred to as film sliding surface) of the substrate 37a, which faces inward of the film loop. Each heat generating resistor 37b is formed of silver/palladium alloy or the like, by screen printing or the like. It extends in the lengthwise direction of the substrate 37a.

Further, the film unit 31 is provided with a pair of electrical contacts 37c, which are on the film sliding surface of the substrate 37a. The electrical contacts 37c are in contact with the pair of heat generating resistors 37b, one for one. The heat generating resistors 37b are connected in series through an electrically conductive pattern 37e formed of silver or the like.

Further, film unit 31 is provided with a gloss coat 37d, as a protective layer, which covers each heat generating resistor 37b, electrically conductive pattern 37e, and a part of each electrical contact 37c, which are on the film sliding surface of the substrate 37a. Not only does the glass coat 37d protect the heat generating resistors 37b, but also, reduces the friction between the inward surface of the film 36 and heater 37.

The above-mentioned heater 37 is fitted in the groove 38a of the supporting member 38 so that it extends in the direction parallel to the generatrix of the film 36, and also, so that the heater 37 contacts the film 36 by its glass coat 37d.

The substrate 37a of the heater 37 is in the form of a rectangular parallelepiped. It is 270.0 mm in length, 5.8 mm in width, and 1.0 mm in thickness. The material for the substrate 37a is alumina. The dimension of the heat generating resistor 37b in terms of the lengthwise direction is 22.0 mm. Each heat generating resistor 37b is 18Ω in electrical resistance.

Referring to FIG. 4, the supporting member 38 is provided with a pair of through holes 38a and 38b, which are in the adjacencies of the lengthwise center of the supporting member 38. It is in the through hole 38a that a thermistors 42, as a temperature detection element, is disposed. It is in the through hole 38b that a temperature fuse 43, as a circuit breaking element, is disposed in contact with the thermally conductive member 39. That is, the thermistor 42 and temperature fuse 43 are in contact with the thermally conductive member 39 so that the heat from the heater 37 is sensed by the thermistor 42 and temperature fuse 43 through the thermally conductive member 39.

In order to stabilize the thermistor 42 in the state of contact between the thermistor 43 and heater 37, the thermistor 42 is disposed with the placement of a piece of ceramic paper or the like between its housing and the heater 37, and is covered with a piece of dielectric tape such as a piece of polyamide tape.

The temperature fuse 43 is such a component that detects the abnormal heat generation of the heater 37, based on the abnormal temperature increase of the heater 37, and interrupts the power supply to the heater 37. It has a cylindrical metallic housing, and a fusible element which melts at a preset temperature and is disposed in the cylindrical metallic housing. As the fusible element of the temperature fuse 43 is melted away by the abnormal temperature increase of the heater 37, the temperature fuse 43 interrupts the power supply to an electrical circuit EC (FIG. 3) for supplying the heater 37 with electrical power. The temperature fuse 43 is attached to the thermally conductive member 39 with the placement of thermally conductive grease between itself and thermally conductive member 39, in order to prevent the malfunction of the fixing device 30, which is attributable to the separation of the temperature fuse 43 from the heater 37.

The film 36 is loosely fitted around the combination of the supporting member 38 (which supports the heater 37), thermally conductive member 39, and pressure stay 40. The film 36 has: a cylindrical substrate; an elastic layer formed on the peripheral surface of the substrate; and a parting layer formed on the outward surface of the elastic layer. The film 36 in this embodiment is 18.0 mm in internal diameter. The substrate is 60 μm in thickness, and is formed of polyamide. The elastic layer is roughly 150 μm in thickness, and is formed of silicone rubber. The parting layer is 15 μm in thickness, and is formed of a piece of PFA resin tube.

The material for the flanges 41 and 42 is liquid polymer resin. The flange 41 has a plate-like regulating portion 41a (FIG. 2) which regulates the film 36 in terms of the movement in the lengthwise direction of the fixing device 30. More specifically, as the film 36 deviates in the lengthwise direction of the fixing device 30, it comes into contact with the regulating portion 41a, being thereby preventing from deviating further. The regulating portion 41a supports the pressure stay 40 and supporting member 38 at one of the lengthwise ends of the fixing device 30. It has a pair of vertical grooves 41a1, which are in its upstream and downstream end surfaces, respectively. The lateral plate 34 (one of lateral plates) of the frame 33 is fitted in this vertical groove 41a1, making it possible for the flange 41 to move relative to the pressure roller 32.

The flange 41 has also an arc-like guide portion 41b, which is in the surface of the regulating portion 41a, which faces the inward surface of the film 36. Not only does the guide portion 41b support the pressure stay 40 and supporting member 38 at one of the lengthwise ends of the fixing device 30, but also, guides the film 36 with its outward surface, as the film 36 is rotationally moved. Moreover, the flange 41 has a spring seat 41c, which is a part of the outward surface of the regulating portion 41a, that is, the opposite surface of the flange 41 from the film 36.

Further, the flange 41 has also a plate-like regulating portion 42a (FIG. 2) which regulates the deviation of the film 36 in the lengthwise direction of the fixing device 30. That is, as the film 36 deviates in the lengthwise direction of the fixing device 30, it comes into contact with the regulating portion 42a, being thereby prevented from deviating further. The regulating portion 42a supports the pressure stay 40 and supporting member 38 at the other end of the fixing device 30. The regulating portion 42a is provided with a pair of vertical grooves 42a1, which are in the upstream and downstream surfaces of the regulating portion 42a, in terms of the recording medium conveyance direction. The other lateral plate 35 of the frame 33 is fitted in this vertical groove 42a1, making it possible for the flange 42 to be moved relative to the pressure roller 32.

Further, the flange 42 has an arc-like guide portion 42b, which is in the surface of the regulating portion 42a, which faces the inward surface of the film 36. Not only does this guide portion 42b support the pressure stay 40 and supporting member 38 at one of the lengthwise ends of the fixing device 30, but also, guides the film 36 with its outward surface, as the film 36 is rotationally moved. Moreover, the flange 42 has a spring seat 42c, which is a part of the outward surface of the regulating portion 41a, that is, the opposite surface of the regulating portion 41a from the film 36.

The pressure roller 32 has a metallic core 32a, an elastic layer 32b, and a parting layer 32c. The elastic layer 32b covers the peripheral surface of the metallic core 32a, except for the shaft portions 32a1 and 32a2 of the metallic core 32a, that is, the lengthwise end portions of the metallic core 32a. The parting layer 32c covers the outward surface of the elastic layer 32b. The material for the elastic layer 32b is silicone rubber, fluorinated rubber, or the like. The material for the parting layer 32c is PFA (tetrafluoroethylene, perfluoroalkylvinylether copolymer), PTFE (polytetrafluoroethylene), FEP (tetrafluoroethylene/hexafluoropropylene copolymer), or the like.

The structure of the pressure roller 32 in this embodiment is as follows: It has metallic core 32a, an elastic layer 32b as the first elastic member layer, and a parting layer 32c. The metallic core 32a is formed of stainless steel, and is 11.0 mm in external diameter. The elastic layer 32b covers the virtual entirety of the peripheral surface of the metallic core 32a. The parting layer 32c covers the outward surface of the elastic layer 32b. More specifically, the elastic layer 32b is silicone rubber layer formed on the peripheral surface of the metallic core 32a to a thickness of roughly 3.5 mm, by injection molding. The parting layer 32b is roughly 40 μm in thickness, and is formed by covering the elastic layer 32b with a piece of PFA resin tube.

The pressure roller 32 is 18.0 mm in external diameter. From the standpoint of formation of a satisfactory nip N, and also, durability, the hardness (measured by ASKER-C hardness gauge, under 9.8 N of weight) of the pressure roller 32 is desired to be in a range of 40°-70°. In this embodiment, the hardness of the pressure roller 32 is 54°. The length of the elastic layer 32b of the pressure roller 32 is 226.0 mm.

Referring to FIG. 2, the shaft portions 32a1 and 32a2 of the metallic core 32a of the pressure roller 32 are rotatably supported by the lateral plates 34 and 35, with the placement of a pair of bearings 50 and 51 between the shaft portions 32a1 and 32a2 and lateral plates 34 and 35, respectively. A driving gear G is fixed to the shaft portion 32a2.

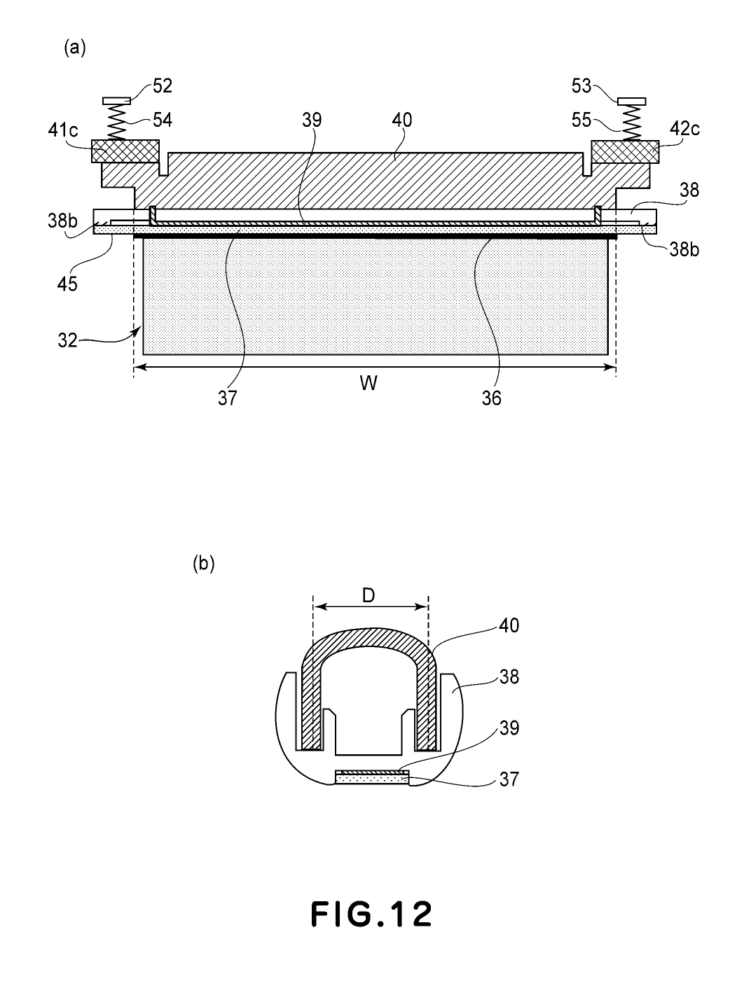

FIG. 12(a) shows the pressure stay 40, supporting member 38, thermally conductive member 39, heater 37, spring seat 41c of flange 41, and spring seat portion 42c of flange 42, as seen from the recording medium conveyance direction. It shows the structure of the fixing device 30. The spring seating portions 41c and 42c are under the pressure generated by a pair of compression springs 54 and 55 disposed between themselves and a pair of pressure application arms 52 and 53, respectively, in the vertical direction, which is perpendicular to the generatrix of the film 36. The spring seat portions 41c and 42c transmit the force they receive from the compression springs 54 and 55, to the supporting member 38 through the pressure stay 40. The supporting member 38 presses the heater 37 against the peripheral surface of the pressure roller 32, with the presence of the thermally conductive member 39 between itself and the heater 37, and the film 36 between the heater 37 and the peripheral surface of the pressure roller 32, forming thereby the nip N (FIG. 1).

The pressure stay 40 is in contact with the supporting member 38 across the entirety of the supporting member 38 in terms of the lengthwise direction. The lengthwise ends of the area of contact between the pressure stay 40 and supporting member 38 are on the outward side of the lengthwise ends of the nip N.

The supporting member 38 makes no contact, except for its contact with the opposite surface of the heater 37 from the surface of the heater 37, which is in contact with the film 36, and its contact with the film 36 by its contacting surface 38b. FIG. 12(b) is a cross-sectional view of the combination of the pressure stay 40, supporting member 38 (minus the contacting surface 38b), thermally conductive member 39, and heater 37, at a plane perpendicular to the lengthwise direction. Referring to FIG. 12(b), the fixing device 30 is structured so that the supporting member 38 makes no contact with the heater 37, except for its contact with the heater 37. This structural arrangement can improve the state of contact between the thermally conductive member 39 and heater 37.

In this embodiment, the total contact pressure between the surface of the pressure roller 32 and the surface of the film 36 is 180 N, and the width of the nip N is roughly 6.2 mm. Further, the inward surface of the film 36 is coated with heat resistant grease, to reduce the friction between the film 36 and heater 37, and also, the friction between the film 36 and supporting member 38.

### (2) Thermally Fixing Operation of Fixing Device 30

The rotational force of the output shaft of the motor M is transmitted to the driving gear G, whereby the pressure roller 32 is rotated in the direction indicated by an arrow mark in FIG. 1. Thus, the film 36 is rotated by the rotation of the pressure roller 32 in the direction indicated by an another arrow mark in FIG. 1, sliding on the heater 37, with the inward surface of the film 36 sliding on the glass coat layer 37d of the heater 37.

As a control portion 100 (FIG. 3) made up of a CPU and memories such as a RAM, a ROM, and the like, turns on a triac 101, electric power is supplied from a commercial power source 102 to the heat generating resistor 37b of the heater 37 through the power supply connector 46, which will be described later. Consequently, the heat generating resistor 37b generates heat, increasing thereby the heater in temperature. The triac 101 is controlled by the control portion 100 so that the temperature detected by the thermistor 42 for monitoring the temperature of the substrate 37a remains a preset fixation temperature (target level).

A sheet P of recording medium (FIG. 1) on which an unfixed toner image t is present is introduced into the nip N while being guided by an entrance guide 60. In the nip N, the heat from the heater 37, and the pressure in the nip N, are applied to the toner image t on the sheet P while the sheet P is conveyed, remaining pinched by the pressure roller 32 and film 36, through the nip N. Consequently, the toner image t is thermally fixed to the sheet P. After the fixation of the toner image t to the sheet P, the sheet P is discharged from the nip N. The dimension (width) of the widest sheet P, in terms of the lengthwise direction, which is conveyable through the fixing device 30 in this embodiment is 216.0 mm.

### (3) Position of Lengthwise End of Pressure Roller 32, Heater 37, Thermally Conductive Member 39, and Supporting Member 38

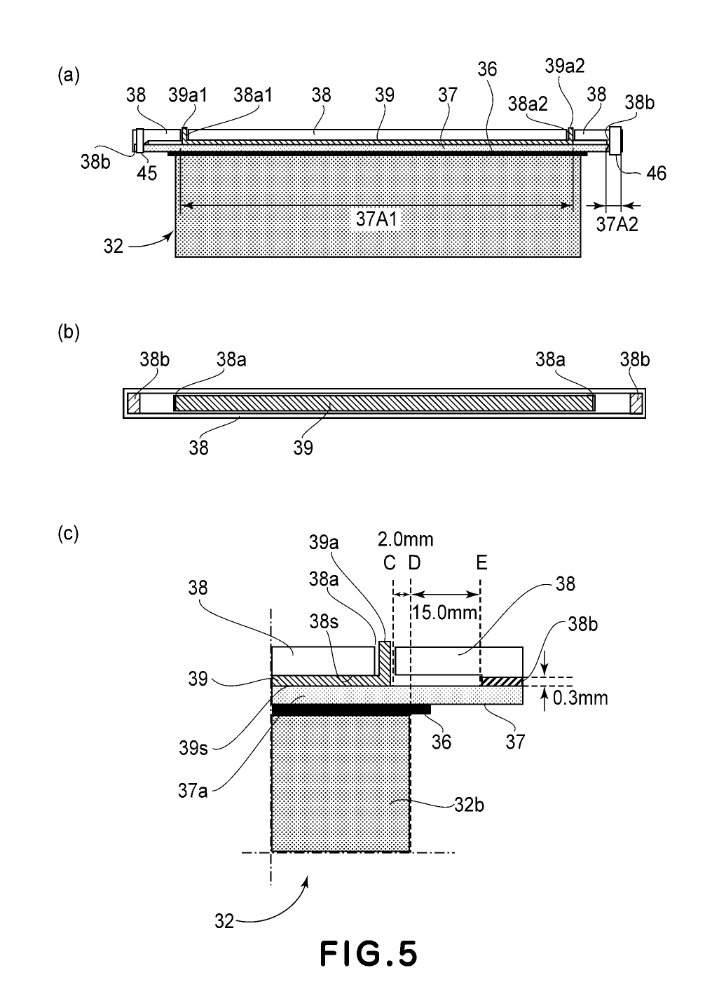

Next, referring to FIG. 5, the characteristic features of the fixing device 30 in this embodiment are described in detail. FIG. 5(a) is a sectional view of the fixing device 30 at a plane I-I, as seen from the direction indicated by a pair of arrowheads. FIG. 5(b) is a plan view of the supporting member 38, as seen from the heater 37 side, after the attachment of the thermally conductive member 39 to the supporting member 38. FIG. 5(c) is a drawing for describing the positional relationship among the supporting member 38, thermally conductive member 39, heater 37, film 36, and pressure roller 32, at one of their lengthwise end portions. In FIG. 5(a), the power supply connector 46 and clip 47 are contoured with solid line, for descriptive discretion. In FIG. 5(b), the power supply connector 46 is not shown, for descriptive discretion.

Hereafter, the surface of the heater 37, which is in contact with the film 36, will be referred to as the first surface, whereas the opposite surface of the heater 37 from the first surface will be referred to as the second surface. Referring to FIG. 5(c), the fixing device 30 is structured so that, in terms of the direction parallel to the generatrix of the film 36, the end C of the portion of the thermally conductive member 39, which is in contact with the second surface of the heater 37, is on the inward side of the end D of the nip N. Further, the fixing device 30 is structured so that the inward end E of the surface 38b (second surface) of the supporting member 38, which is in contact with the second surface of the heater 37, is on the outward side of the end D of the nip N. Further, the fixing device 30 is structured so that the area (first area) of the supporting member 38, which is between the end C and end E does not contact the second surface of the heater 37. The end D of the nip N coincides in position with the end of the pressure roller 32.

The thermally conductive member 39 in this embodiment is a piece of aluminum plate which is uniform in thickness. It is 0.3 mm in thickness. From the standpoint of minimizing the out-of-sheet-path temperature increase, that is, the phenomenon that when a substantial number of small prints are continuously outputted, the out-of-sheet-path portions of the heater 37 excessively increases in temperature, the area of contact between the thermally conductive member 39 and heater 37 is desired to be no less in length than the heat generating resistor 37b of the heater 37. However, in consideration of the temperature drop which occurs across the lengthwise end portions of the sheet-path portion (FIG. 2) of the heater 37, the length of the area of contact between the thermally conductive member 39 and heater 37 is desired not to be excessive.

Regarding the shape of the area of contact between the thermally conductive member 39 and heater in this embodiment, the area of contact is straight and rectangular. The length of the area of contact in terms of the direction parallel to the generatrix of the film 36 is 222.0 mm which is the same as the length of the heat generating resistor 37b of the heater 37, and the width of the area of contact in terms of the direction perpendicular to the generatrix of the film 36 is 5.0 mm. Since the pressure roller 32 is 226.0 mm in length, the lengthwise end C of the thermally conductive member 39 is on the inward side of the end D by 2.0 mm.

The thermally conductive member 39 has a pair of bent portions 39a1 and 39a2, which are at the ends of the thermally conductive member 39, one for one, in terms of the direction parallel to the generatrix of the film 36. The bent portions 39a1 and 29a2 are inserted into, and remain in, a pair of holes 38a1 and 38a2, with which the end portions of the supporting member 38, in terms of the direction parallel to the generatrix of the film 36, is provided. The holes 38a1 and 38a2 are for absorbing the difference in coefficient of linear expansion between the thermally conductive member 39 and supporting member 38, and are made slightly larger in size than the bent portions 39a1 and 39a2. As the material for the thermally conductive member 39, not only a metallic substance such as aluminum and copper, but also, graphite, which are higher in thermal conductivity than the substrate 37a of the heater 37, can be used.

At this time, the role of the thermally conductive member 39 is described. The role of the thermally conductive member 39 is to keep the heater 37 uniform in temperature to prevent the problem that as the out-of-sheet-path temperature increase occurs due to the continuous outputting of a substantial number of small prints, such components as the heater 37, film 36, supporting member 38, pressure roller 32, etc., of the fixing device 30 are thermally damaged.

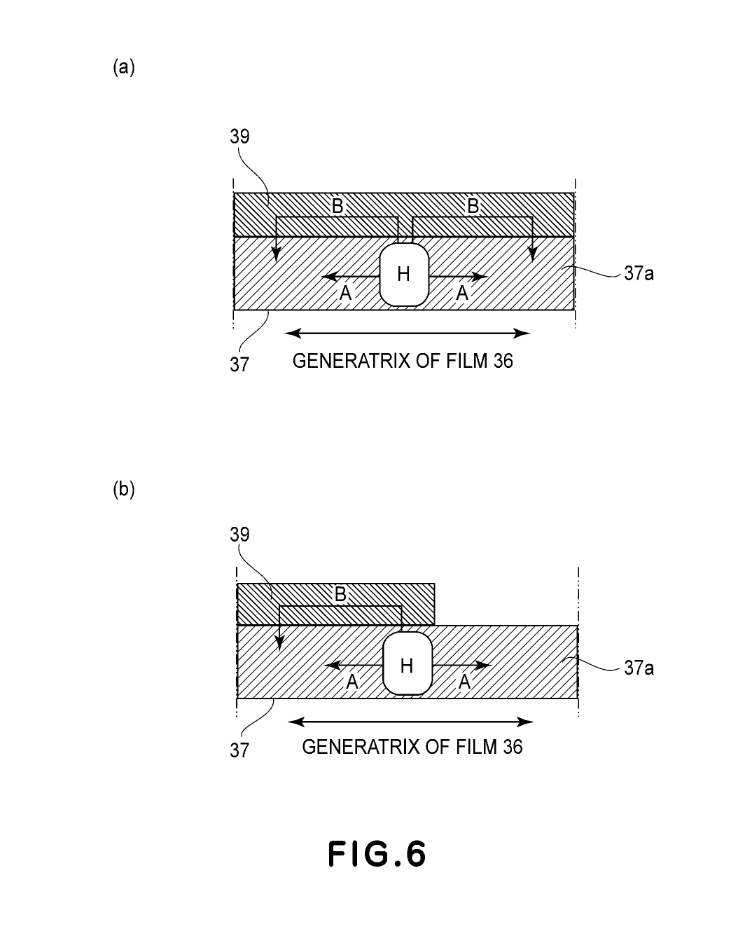

Next, referring to FIG. 6, how the heater 37 is kept uniform in temperature is described. FIG. 6(a) is a drawing for describing the heat flow through the heater 37 and thermally conductive member 39 in terms of the direction parallel to the generatrix of the film 36. FIG. 6(b) is for describing the heat flow in the lengthwise end portion of the heater 37 and that of the thermally conductive member 39.

Alumina, which is used as the material for the substrate 37a of the heater 37, is roughly 26 W/mK in thermal conductivity. In comparison, aluminum, which is used as the material for the thermally conductive member 39, is roughly 230 W/mK, which is higher than that of the substrate 37a.

Let's think about a case in which a portion H of the substrate 37a, in terms of the direction parallel to the generatrix of the film 36, became higher in temperature than the rest of the substrate 37a. In such a case, heat flows not only in the substrate 37a in the direction indicated by an arrow mark A, which is parallel to the generatrix of the film 36, but also, from the substrate 37a to the thermally conductive member 39 through the area of contact between the substrate 37a and thermally conductive member 39. Further, the heat having flowed into the thermally conductive member 39 flows in the thermally conductive member 39 in the direction indicated by the stem portion of arrow marks B, which is parallel to the generatrix of the film 36 to return to the substrate 37a. Thus, the heater 37 is made uniform in heat (temperature) by this circular flow of heat, whereby the out-of-sheet-path temperature increase is minimized.

However, the heater 37 is made uniform in heat (temperature) even when the largest sheets of recording medium, in terms of the direction perpendicular to the recording medium conveyance direction, are conveyed (which hereafter may be referred to as widest sheet P). Thus, if the thermally conductive member 39 is made long enough to extend into the portions of the heater 37, which do not contact the film 36, heat is likely to escape from the area of the heater 37, which has the heat generating resistor 37b, to the area of the heater 37, which does not have the heat generating resistor 37b. Thus, it is possible that when sheets P of recording medium, which are the same in width as the sheet passage of the fixing device 30, are conveyed through the nip N, the portions of toner image, which correspond in position to the lateral edge portions of the sheet, will be unsatisfactorily fixed.

Referring to FIG. 6(b), in a case where only the portions of the heater 37, which correspond to the adjacencies of the lengthwise end of the thermally conductive member 39, become high in temperature, heat primarily flows toward only one end (left end in FIG. 6(a)) since the thermally conductive member 39 is on only one side (left side). That is, it is unlikely for heat to escape to an area other than where the thermally conductive member 39 is present. Therefore, the out-of-sheet-path temperature increase can be minimized, while preventing the temperature decrease of the end portions of the sheet-path portion of the heater 37, by structuring the fixing device 30 so that the thermally conductive member 39 is on the inward side of the end D of the pressure application area of the pressure roller 32, instead of across the entirety of the area of contact between the substrate 37a of the heater 37 and the film 36.

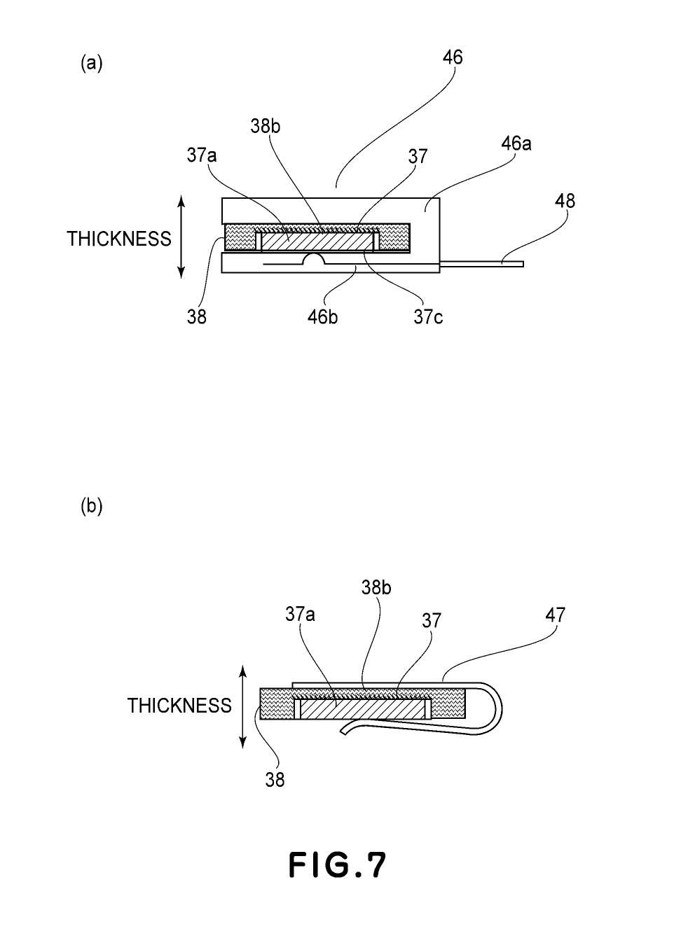

Next, referring to FIG. 7, the power supply connector 46 and clip 47 as holding members are described about their structure. FIG. 7(a) is a drawing for describing the power supply connector 46, and FIG. 7(b) is a drawing for describing the clip 47.

In this embodiment, the heater 37 is held to the supporting member 38, by both of its lengthwise ends, in terms of the direction parallel to the generatrix of the film 36, with the use of power supply connector 46 or clip 47.

Referring to FIG. 7(a), the power supply connector 46 has a housing 46a and a contact terminal 46b. The housing 46a is U-shaped, and is formed of a resinous substance. It sandwiches the heater 37 and supporting member 38 from the outward side of the combination of the heater 37 and supporting member 38, preventing thereby the end portions of the heater 37, in terms of the direction parallel to the generatrix of the film 36, from moving in the thickness direction of the heater 37. As for the contact terminal 46b, it is an integral part of the housing 46a. It elastically contacts the electrical contact 37c of the heater 37, establishing electrical contact between itself and heater 37, while maintaining a present amount of contact pressure between itself and heater 37. Further, it is in contact with a wire bundle 48, which is in contact with unshown commercial power supply and triac.

In this embodiment, the contact terminal 46b of the power supply connector 46 is an integral part of the housing 46a of the contact terminal 46b. However, the power supply connector 46 may be structured so that its housing and contact terminal are physically independent from each other.

Next, referring to FIG. 7(b), the clip 47 is shaped like a letter U, and is formed of a piece of metallic plate. It elastically sandwiches the combination of the heater 37 and supporting member 38, from the outward side of the combination to prevent the lengthwise end portions of the heater 37, in terms of the direction parallel to the generatrix of the film 36, from moving in the thickness direction of the heater 37.

Further, the power supply connector 46 and clip 47 are for regulating both of the lengthwise ends of the heater 37, in terms of the direction parallel to the generatrix of the film 36, to prevent them from moving in the thickness direction of the film 36. They are structured so that they allow the lengthwise ends of the heater 37 to move in the direction parallel to the surface of the substrate 37a of the heater 37, on which the film 36 slides. In other words, they are structured to prevent the problem that as the heater 37 is thermally expanded, and/or is deformed when it is subjected to pressure, or separated, it is unnecessarily subjected to stress.

In this embodiment, an end support surface 38b of the supporting member 38, to which the heater 37 is held by the power supply connector 46 and clip 47, is 7.0 mm in width. In terms of the direction parallel to the generatrix of the film 36, the end E of this end support surface 38b is on the outward side of the nip N formed by the pressure roller 32, and is 15.0 mm apart from the position D of the pressure application area of the pressure roller 32. The dimension of the end support surface 38b, in terms of the thickness direction of the heater 37, is 0.3 mm.

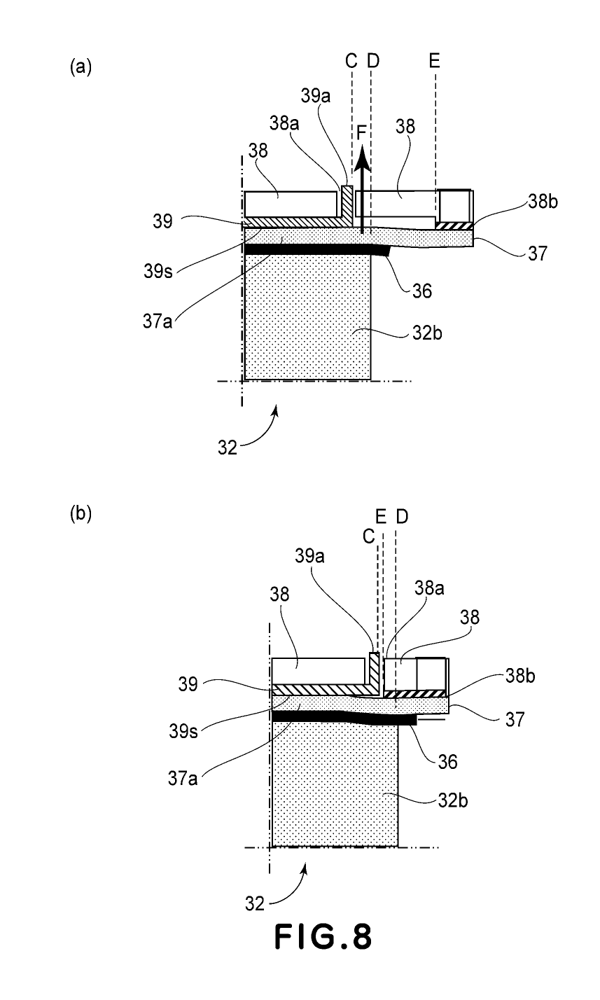

Next, referring to FIG. 8, the mechanism which ensures that the heater 37 and thermally conductive member 39 remain in contact with each other at their lengthwise ends, regardless of the component tolerance of the fixing device 30, is described.

FIG. 8(a) is a drawing for describing the state of contact between the end portion of the thermally conductive member 39, and the heater 37, at one of the lengthwise ends of the heater 37, in the fixing device 30 in this embodiment. FIG. 8(b) is a drawing for describing the state of contact between the end portion of the thermally conductive member 39, and the heater 37, at one of the lengthwise end portions of the heater 37, in the comparative fixing device 30. In FIG. 8(b), the power supply connector 46 is not shown for descriptive discretion.

In this embodiment, in terms of the lengthwise direction of the heater 37, the center portion of the heater 37 is in contact with the thermally conductive member 39, being thereby supported by the thermally conductive member 39. The contact surface 38b of the supporting member 38 is protrusive by 0.3 mm toward the pressure roller 32, relative to a surface 38s (FIG. 5(c)) of the supporting member 38, which is in contact with the thermally conductive member 39, whereas the thermally conductive member 39 is 0.3 mm in thickness. Thus, if the components of the fixing device 30 have no error in dimension, the end support surface 38b will be level with the surface 39s of the thermally conductive member 39, which is in contact with the heater 37, as shown in FIG. 5(c).

Next, referring to FIG. 8(a), a case in which the contact surface 38b of the supporting member 38 is protrusive by 0.1 mm toward the pressure roller 32 relative to the surface 39s of the thermally conductive member 39, which is in contact with the heater 37, because of component tolerance, that is, there is a step between the two surfaces 38b and 39s, is discussed.

FIG. 8(b) shows the structure of a comparative fixing device, which is structured so that the outward end C of the thermally conductive member 39 is on the inward side of the end D of the pressure application area of the pressure roller 32, and the inward end E of the area 38b of contact of the supporting member 38 is between the outward end C of the thermally conductive member 39, and the end D of the nip N. Referring to FIG. 8(b), the area 38b of contact of the supporting member 38 causes the heater 37 to deform toward the pressure roller 32. This deformation sometimes reaches as far as the area of the heater 37, which corresponds in position to the end C of the thermally conductive member 39, causing the heater 37 to separate from the thermally conductive member 39. This separation of the end portion of the thermally conductive member 39 from the heater 37 is problematic in that it makes it impossible for the thermally conductive member 39 to make satisfactorily uniform in the amount of heat, the portion of the heater 37, which corresponds to the end portion of the thermally conductive member 39, in terms of the lengthwise direction of the thermally conductive member 39.

Next, referring to FIG. 8(a), a case in which the aforementioned step occurred in the fixing device 30 described with reference to FIG. 5(c) is described. As the heater 37 is pressed by the contact surface 38b toward the pressure roller 32, it deforms as if it rotates about the end D of the nip N. One of the reasons for the occurrence of this rotational deformation is that the fixing device 30 is structured so that the area (first area) of the supporting member 38, which is between the end C and end E, does not contact the second surface of the heater 37, and therefore, is likely to be easily deformed. The second reason is that on the inward side of the end D of the nip N, the heater 37 is subjected to a force F, shown in FIG. 8(a), being enable to resist the force which works in the direction to deform the heater 37, whereas on the outward side of the end D, it is not subjected to the force F, being thereby likely to be easily deformed. Thus, the deformation of the heater 37 does not reach to the portion of the heater 37, which corresponds in position to the end C of the thermally conductive member 39. Therefore, it is ensured that the end portion of the thermally conductive member 39, and the heater 37, remain in contact with each other. By the way, in FIG. 8(a), the end C of the thermally conductive member 39 is positioned on the inward side of the end D of the nip N, in consideration of the tolerance in component dimension. However, the fixing device 30 may be structured so that the end C coincides with the end D.

As described above, according to this embodiment, it is possible to ensure that the heater 37 and thermally conductive member 39 remain in a better state of contact with each other regardless of the tolerance in component dimension. In other words, this embodiment is effective to keep the heater 37 uniform in temperature.

In this embodiment, the thermally conductive member 39 is a single piece of thermally conductive substance. However, it may be made up of multiple pieces of thermally conductive substance.

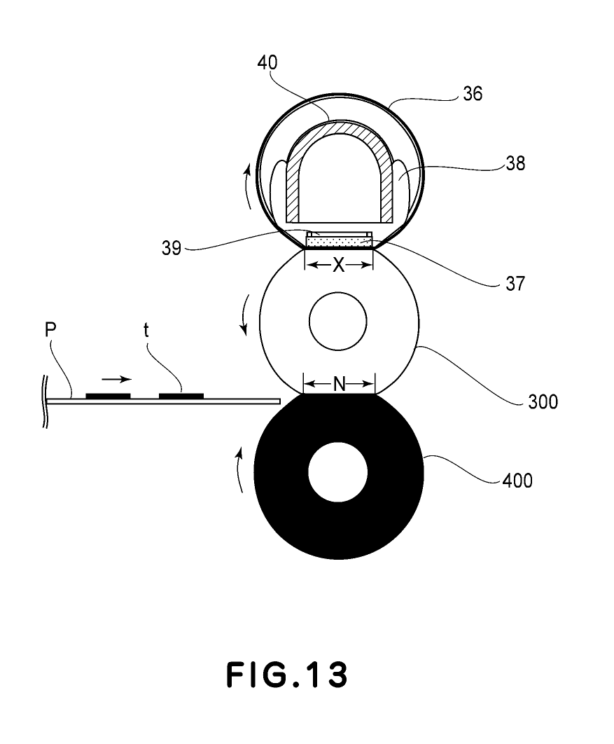

Further, in this embodiment, the fixing device 30 is structured so that the heater 37 forms the nip N, with the pressure roller 32, with the presence of the film 36 between itself and pressure roller 32. However, the fixing device 30 may be structured so that the heater 37 and a fixation roller 300 form a heating-pressing portion X, with the presence of the film 36 between the heater 37 and fixation roller 300 (modified version of first embodiment) as shown in FIG. 13. In the case of this modified version of the first embodiment, the fixation roller 300 is heated by the film 36, in the heating-pressing portion X, and the fixation roller 300 is placed in contact with the pressure roller 400 to form the nip N through which recording medium is conveyed.

### Embodiment 2

Next, another example of fixing device 30 in accordance with the present invention is described. The fixing device 30 in this embodiment is the same in structure as the fixing device 30 in the first embodiment, except for the structure of its pressure roller 32.

FIG. 10 is a drawing for describing the characteristic features of the fixing device 30 in this embodiment, more specifically, the positional relationship among its supporting member 38, thermally conductive member 39, heater 37, film 36, and the lengthwise end of the pressure roller 32. In FIG. 10, the power supply connector 46 is not shown for descriptive discretion.

Referring to FIG. 10, the pressure roller 32 is provided with a rubber ring 32d, as the second opposing member, which is on the outward side of the elastic layer 32b (first opposing member) for forming the nip N. In terms of the lengthwise direction, a gap 32a1 is provided between the elastic layer 32b and rubber ring 32d. The rubber ring 32d is the same in material as the elastic layer 32b. It is 18 mm in external diameter, and 5 mm in width. The rubber ring 32d presses on the heater 37, between the outward end C of the thermally conductive member 39, and the inward end E of the contact surface 38b. Therefore, the heater 37 is subjected to a force F shown in FIG. 10. This force F can prevent the heater 37 from deforming in the adjacencies of the end C of the thermally conductive member 39, and therefore, can improve the fixing device 30 in the state of contact between the heater 37 and thermally conductive member 39 across the lengthwise end portion of the thermally conductive member 39.

In terms of the lengthwise direction, the end C of the thermally conductive member 39 is the same in position as the end of the nip N (elastic layer 32b), or on the inward side of the end of the nip N (elastic layer 32b). Further, the supporting member 38 has the first area which extends from the end C of the thermally conductive member 39 to the outward side of the end D of the rubber ring 32d, and the second area which is in contact with the second surface, on the outward side of the first area. Here, the “second surface” means the opposite surface of the heater 37 from the surface of the heater 37, which is in contact with the film 36.

In the case of the fixing device 30 in this embodiment, the pressure roller 32 is provided with the rubber ring 32d in addition to the elastic layer 32b. Therefore, it is ensured that the heater 37 remains in a better state of contact with the thermally conductive member 39. Also in the case of the fixing device 30 in this embodiment, the amount of the force F for preventing the deformation of the heater 37 can be optionally set by adjusting the rubber ring 32d in external diameter. In other words, even if the tolerance set for the components of the fixing device 30 is relatively large, the state of contact between the heater 37 and thermally conductive member 39 can be improved by adjusting the rubber ring 32d in external diameter.

The characteristic effects of the fixing device 30 in this embodiment are as follows: The heat from the heater 37 is likely to escape from the lengthwise ends of the pressure roller 32, through the parting layer 32c (surface layer), elastic layer 32b, and metallic core 32a. Thus, if the elastic layer 32b of the pressure roller 32 is simply increased in size in the lengthwise direction to form the rubber ring 32d, it is likely for the portions of the heater 37, which correspond in position to the lengthwise end portions of the pressure roller 32, to decrease in temperature, and therefore, it is possible that the portions of the toner image, which are on the lateral edge portion of a sheet of recording medium, will be unsatisfactorily fixed.

In comparison, in the case of the fixing device 30 in this embodiment, the gap 32a1 is provided between the elastic layer 32b and rubber ring 32d of the pressure roller 32. That is, the elastic layer 32b and rubber ring 32d are not in contact with each other. Therefore, this structural arrangement makes it more difficult for the heat in the lengthwise end portions of the elastic layer 32b to escape than the structural arrangement which simply extends the elastic layer 32b. Therefore, it makes it less likely for the lengthwise end portions of the heater 37 to reduce in temperature.

As described above, this embodiment can keep the heater 37 and thermally conductive member 39 in the better state of contact with each other to minimize the temperature reduction which occurs to the lengthwise end portions of the heater 37. That is, it is more effective to keep the heater 37 uniform in temperature in terms of the lengthwise direction.

Incidentally, instead of providing the gap 32a1 as in this embodiment, the portion of the metallic core 32a, which corresponds to the gap 32a1, may be increased in external diameter to provide a portion like a stair step.

### Embodiment 3

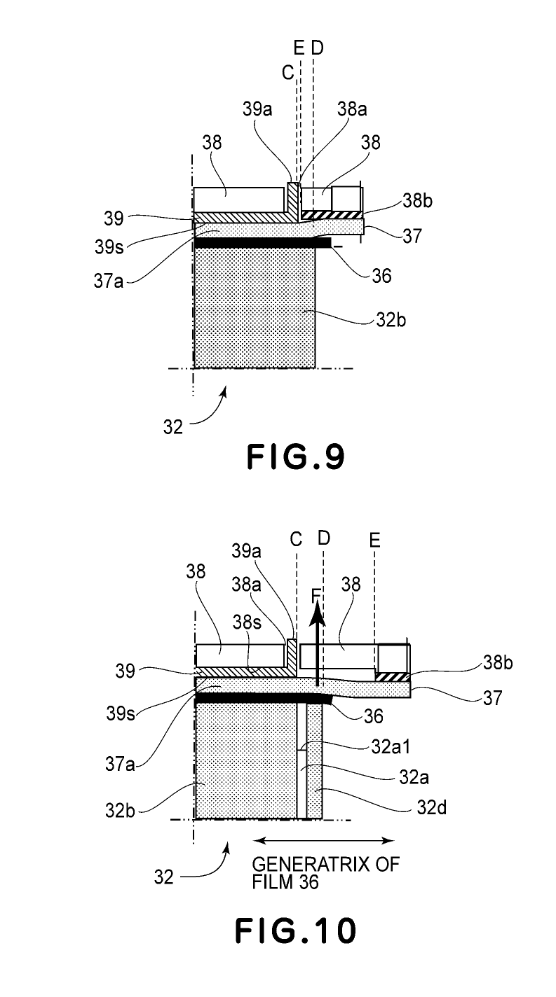

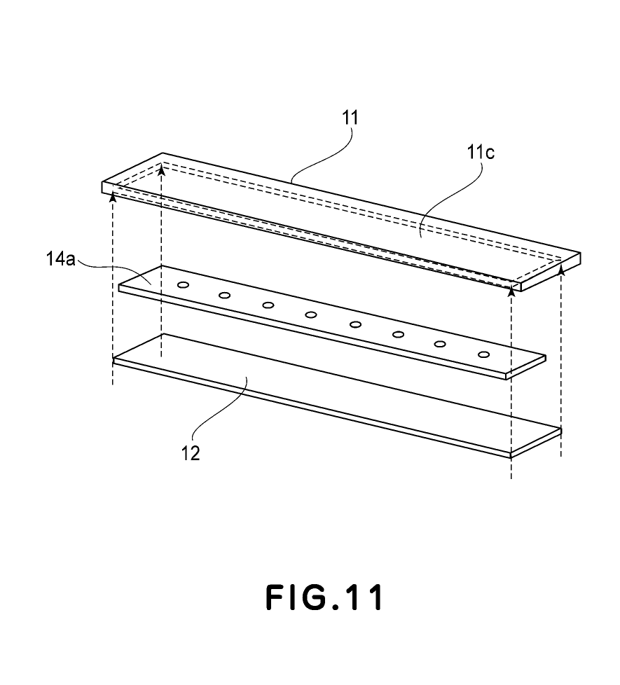

The fixing device in this embodiment is the same in structure as the one in the first embodiment, except for its portions which are described next. Therefore, the general structure of this fixing device is not described. FIG. 9 is a drawing of one of the lengthwise end portions of another modified version of the fixing device 30 in the first embodiment. It is for describing the positional relationship among the supporting member 38, thermally conductive member 39, heater 37, film 36, and pressure roller 32, at one of the lengthwise ends of the fixing device. In FIG. 9, the power supply connector 46 is not shown for descriptive discretion.

The fixing device 30 structured so that the inward end E of the contact surface 38b (second area) of the supporting member 38 is between the end C of the thermally conductive member 39 and the end D of the nip N may be modified in structure as follows.

Referring to FIG. 9, it may be structured so that the contact surface 38b of the supporting member 38 is offset from the area of contact between the thermally conductive member 39 and heater 37. This structural arrangement can absorb the component tolerance by the offset, and therefore, can ensure that the heater 37 remains in the better state of contact with the thermally conductive member 39.

As described above, the fixing device 30 in this embodiment can ensure that the heater 37 remains in contact with the thermally conductive member 39 regardless of component tolerance. Therefore, it is greater in its effectiveness to keep the heater 37 uniform in temperature with the use of the thermally conductive member 39.

By the way, the fixing devices in the first, second, and third embodiments were for heating the unfixed toner image t on the sheet P of recording medium to fix the toner image to the sheet P. However, the present invention is also applicable to an image heating device for heating a fixed image on a sheet P of recording medium to increase the image in gloss.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims priority from Japanese Patent Applications Nos. 151617/2013 and 128147/2014 filed Jul. 22, 2013 and Jun. 23, 2014, respectively, which are hereby incorporated by reference.

What is claimed is:

1. A fixing device for fixing a toner image formed on a recording material, on a recording material, said fixing device comprising:
a cylindrical film;
a heater having a first surface contacting an inner surface of said film;
an opposed member cooperating with said heater to form a press-contact portion with said film interposed therebetween;
a supporting member for supporting a second surface of said heater opposite the first surface; and
a heat conduction member contacting said second surface,
wherein with respect to a generatrix direction of said film, an end portion of a contact region between said heat conduction member and said second surface is at or inside an end portion of said press-contact portion, and
wherein in a region from an end portion of the contact region to an outside of an end portion of said press-contact portion with respect to the generatrix direction, said supporting member includes a first region not contacting said second surface and a second region contacting said second surface outside said first region.

2. The apparatus according to claim 1, wherein said heater includes a substrate and a heat generating resistor on said substrate, and said heat conduction member has a thermal conductivity higher than that of said substrate.

3. The apparatus according to claim 1, wherein said supporting member is out of contact with said second surface except for the second region.

4. The apparatus according to claim 1, wherein said press-contact portion provides a nip for feeding the recording material.

5. The apparatus according to claim 1, further comprising a back-up member, wherein said opposed member is in the form of a roller, and said back-up member provides a nip for feeding the recording material in contact with a portion of said roller different from a portion contacted by said film.

6. The apparatus according to claim 1, wherein said heat conduction member is made of metal or graphite.

7. The apparatus according to claim 1, further comprising a reinforcing member, wherein said reinforcing member contacts a side of said supporting member opposite a surface contacting said heat conduction member to reinforce said supporting member.

8. The apparatus according to claim 7, wherein with respect to the generatrix direction, an end portion the of the region of said reinforcing member contacting said supporting member is outside an end portion of said press-contact portion.

9. A fixing device for fixing a toner image formed on a recording material, on a recording material, said fixing device comprising:
a cylindrical film;
a heater having a first surface contacting an inner surface of said film;
a first opposed member cooperating with said heater to form a first press-contact portion with said film interposed therebetween;
a second opposed member cooperating with said heater to form a second press-contact portion with said film interposed therebetween, said second opposed member being outside of an end portion of said roller with respect to the generatrix direction and being out of contact with an end portion of said first opposed member.
a supporting member for supporting a second surface of said heater opposite the first surface; and
a heat conduction member contacting said second surface,
wherein with respect to a generatrix direction of said film, an end portion of a contact region between said heat conduction member and said second surface is at or inside an end portion of said first press-contact portion, and
wherein in a region from an end portion of the contact region to an outside of a end portion of said second press-contact portion with respect to the generatrix direction, said supporting member includes a first region not contacting said second surface and a second region contacting said second surface outside said first region.

10. The apparatus according to claim 9, further comprising a first rotatable member and a second rotatable member co-axial with said first opposed member and said second opposed member, respectively, wherein an outer diameter of said second rotatable member is larger than that of said first rotatable member.
